(19) United States
(12) Patent Application Publication
(10) Pub. No.: US 2017/0079877 A1
(43) Pub. Date: Mar. 23, 2017

(54) Clip Design

(71) Applicant: Sundance Spas, Inc., Chino, CA (US)

(72) Inventors: John Clark, Huntington Beach, CA (US); Adrian Alfaro, Menifee, CA (US)

(21) Appl. No.: 15/266,605

(22) Filed: Sep. 15, 2016

Related U.S. Application Data
(60) Provisional application No. 62/219,948, filed on Sep. 17, 2015.

(51) Int. Cl. A61H 33/00; F16B 2/22; F16B 5/06

(52) U.S. Cl. CPC A61H 33/6005; F16B 5/0685; F16B 2/22

(57) ABSTRACT

The present invention relates to a clip design for a spa tub. The spa tub includes a frame defining a receptacle. The frame having a wall including one of a projection or a clip and a panel including the other one of the projection or the clip. Receipt of the projection by the clip removably connects the panel to the frame advantageously simplifying the mechanism by which access is gained to the inner workings of the spa tub, thereby streamlining inspection, maintenance, and repair thereof.

### CROSS REFERENCE TO RELATED APPLICATION

This application claims the benefit of U.S. Provisional Patent Application No. 62/219,948, filed on Sep. 17, 2015, the disclosure of which is incorporated herein by reference in its entirety.

### BACKGROUND OF THE INVENTION

Field of the Invention

The present invention relates to spa tubs and more particularly to spa tubs having a clip design for removably securing spa panels to a frame thereof.

Description of Related Art

Spa tubs generally include a frame that forms a skeleton of the tub. Spa panels are typically attached to the outside of the frame. Many of the inner workings of the spa tub (e.g., pumps, pipes, filters, etc.) are located within the frame and enclosed behind the panels.

Spa panels have historically been permanently affixed to the frame, for example, fastened to the frame using screws. Permanently affixing the panels to the frame has made accessing the inner workings for the purpose of inspection, maintenance, or repair exceedingly complicated. Additionally, permanently affixed spa panels experience significant stress due to the expansion and contraction of the panels as a result of variation in temperature, making the panels more likely to fatigue and fail over time.

### SUMMARY OF THE INVENTION

Provided herein is a spa tub having a clip design. The tub includes a frame defining a receptacle. The frame includes a wall having one of a projection or a clip. The tub also includes a panel having the other one of the projection or the clip. Receipt of the projection by the clip connects the panel to the frame. The panels are removably connected to the frame. The frame also includes a corner beam for connecting a plurality of walls to each another.

The wall includes a beam extending in a first direction and a beam extending in a second direction. A cavity for receiving a portion of the panel is defined in the beam extending in the first direction and the projections are connected to the beam extending in the second direction.

The clips are secured to a rear side of the panel and include opposing, biased members defining a receiving portion therebetween for receiving and securing the projection. A shape of the receiving portion of the clip corresponds in shape to a shape of a cross section of the projection. In one particular embodiment, the projection is cylindrical.

The panel further includes a lip for abutting with the frame when the panel is connected to the frame and a mount secured to a rear side of the panel. The mount includes a tab. A portion of the tab is configured to be inserted into the cavity, such that the tab floats within the cavity when the cavity receives the portion of the tab.

The panel further includes a flange configured to engage a flange of an adjacent panel when a plurality of panels are affixed to the frame adjacent to one another.

A method of making a tub having a clip design is also provided. The method includes providing a frame, which defines a receptacle, and includes a wall having a projection or a clip. The method further includes providing a panel including the other one of the projection or the clip and attaching the panel to the frame. Receipt of the projection by the clip connects the panel to the frame. The panels are removably connected to the frame.

In one embodiment, the frame comprises the projection and defines a cavity and the panel comprises a mount and a clip. The step of attaching the panel to the frame further includes aligning the projection and the clip by inserting a portion of the mount into the cavity and pivoting the panel until the clip receives the projection.

A method of gaining access to an interior of a tub is also provided. The spa tub includes a frame defining a receptacle. The frame having a wall including a projection or a clip. The spa tub further includes a panel having the other one of the projection or the clip. Receipt of the projection by the clip removably connects the panel to the frame. The method of gaining access includes removing the panel, accessing inner workings of the tub, and reattaching the panel to the frame. The step of removing the panel further includes disconnecting the projection from the clip and lifting the panel to disengage a mount secured to the panel from a receiving cavity defined in the frame.

### BRIEF DESCRIPTION OF THE DRAWINGS

The present invention will now be described in further detail with reference to the accompanying figures, in which:

FIG. 1 is a perspective view of an embodiment of a spa tub made in accordance with the present invention;

FIG. 2 is a perspective view of FIG. 1 with a panel of the spa tub having been removed;

FIG. 3A is a perspective view of a portion of a panel having a clip and a portion of a frame having a projection in accordance with an embodiment of the present invention, when the panel is not secured to the frame;

FIG. 3B is a perspective view of the arrangement of FIG. 3A with the projection received by the clip;

FIG. 4 is an exploded top perspective view of a spa tub frame in accordance with an embodiment of the present invention;

FIG. 5 is a perspective view of a side wall of the spa tub frame in accordance with an embodiment of the present invention;

FIG. 6 is a rear elevation view of a side panel of the spa tub in accordance with an embodiment of the present invention;

FIG. 7A is a cross-section view of the side wall of the spa tub frame defining a cavity and having a clip and a side panel of the spa tub frame having a mount and a projection, when the mount is inserted into the cavity and the clip has not received the projection;

FIG. 7B is a front elevation view of the arrangement of FIG. 7A with the projection received by the clip;

FIG. 8 is an exploded perspective view of a mount secured to a spa tub panel in accordance with an embodiment of the present invention;

FIG. 9 is an exploded perspective view of a clip secured to a spa tub panel in accordance with an embodiment of the present invention; and

FIG. 10 is a rear perspective view of a corner panel of the spa tub in accordance with the present invention.

### DETAILED DESCRIPTION OF THE INVENTION

The following description is provided to enable those skilled in the art to make and use the described embodiments contemplated for carrying out the invention. For purposes of the description hereinafter, the terms “upper”, “lower”, “vertical”, “horizontal”, “top”, “bottom”, “lateral”, “longitudinal” and derivatives thereof relate to the invention as it is oriented in the drawing figures. It is to be understood that the specific devices illustrated in the attached drawings, and described in the following specification, are simply exemplary embodiments of the invention. Hence, specific dimension and other physical characteristics related to the embodiments disclosed herein are not to be understood as limiting.

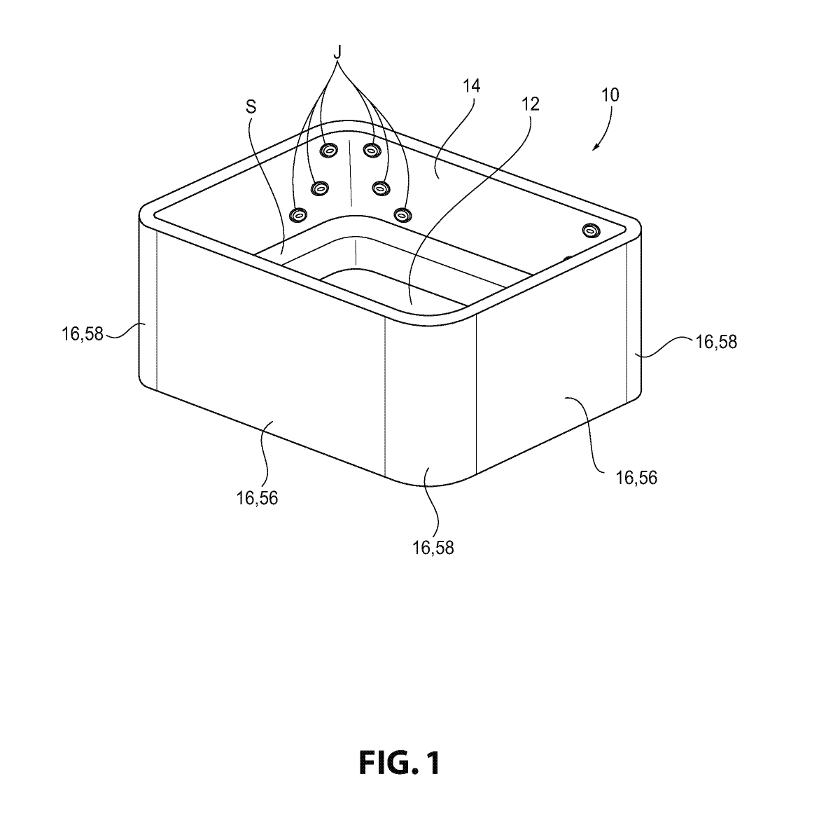

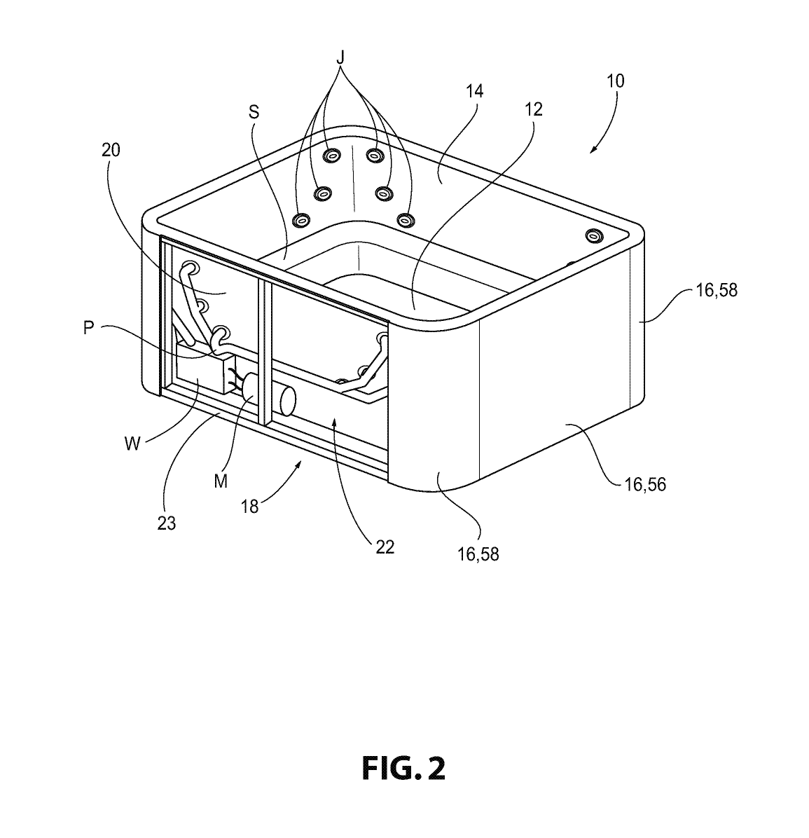

FIGS. 1 and 2 illustrate a spa tub made in accordance with the present invention. The spa tub 10 generally includes a floor or bottom 12, which is parametrically surrounded by side walls 14 to which spa panels 16 are attached. Together, the floor 12 and the side walls 14 form a frame 18 that houses a shell 20 and mechanical inner workings 22, such as the mechanical arrangement disclosed in U.S. Pat. No. 8,407,823, which is hereby incorporated by reference. The mechanical inner workings 22 may include a motor M, a water pump W, filters (not shown), and piping P. The motor M and water pump W provide pressurized water to a plurality of jets J positioned on the shell 20. The shell 20 generally defines one or more seats S for the comfort of a user sitting or lying within the shell.

The spa panels 16 are removably connected to an exterior portion 23 of the frame 18, thereby simplifying disconnection of the spa panels 16 from the frame 18 and providing a user with an efficient mechanism by which access can be gained to the mechanical inner workings 22. As a result, the present invention streamlines the process of inspecting the inner workings 22 of the spa tub 10 and making necessary repairs thereto.

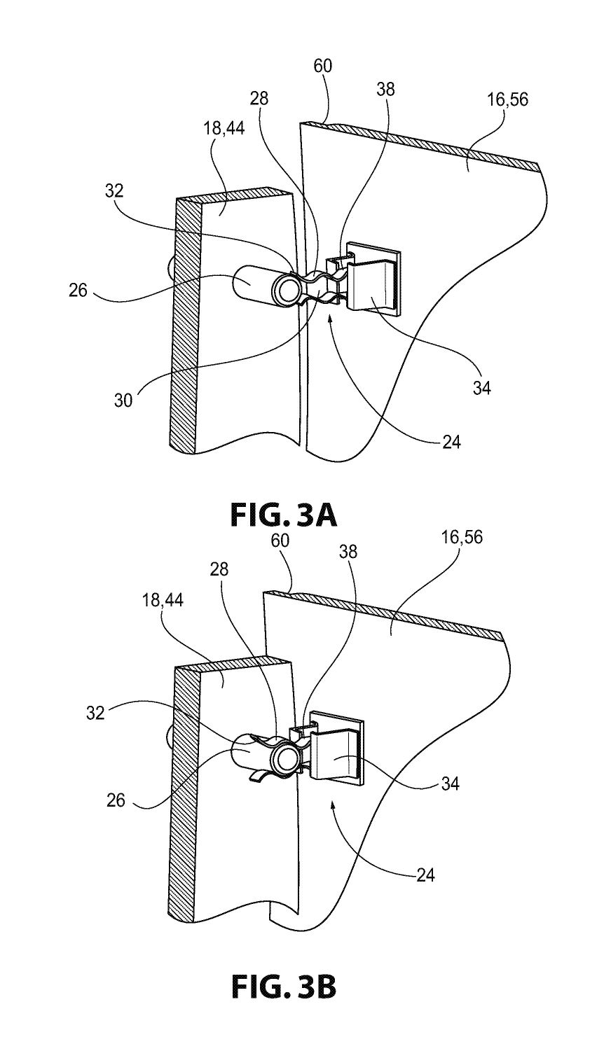

Referring to FIGS. 3A, 3B, and 9, clips 24 are secured to the spa panels 16 and projections 26 are secured to the frame 18. The projections 26 are removably attachable to the clips 24 for securing the spa panels 16 to the frame 18. The clip design of the present invention need not be limited to a spa tub and may be used with any receptacle containing water, such as a bathtub or a pool.

The clips 24 includes opposing, biased members 28, spaced apart from one another and defining a receiving portion 30 therebetween, for receiving and securing a corresponding projection 26. The opposing members 28 may be formed from spring steel although it is contemplated that any resilient material may be used. A distance that the biased members 28 are spaced from one another may vary from a first end 32 of the clip 24 to a second end 38 of the clip 24. The first end 32 of the clip 24 is affixed to the spa panel 16 via a bracket 34 and screws 36, as shown in FIG. 9. The receiving portion 30, positioned between the first end 32 and the second end 38, corresponds in shape to a cross-sectional shape of the projections 26. For example, the opposing biased members 28 shown in FIGS. 3A, 3B, and 9 each form an arcuate or U-shaped portion for receiving the cylindrical projection 26, having a circular cross section therebetween. However, it is understood that the projections 26 can be any shape corresponding to the shape of the receiving portion 30 so long as the projections 26 can be removably secured to the clips 24 in a manner that provides a secure attachment of the spa panels 16 to the frame 18.

The distance the biased opposing members 28 are spaced apart, generally decreases from the second end 38 of the clip 24 to the receiving portion 30. Accordingly, after the projection 26 engages the second end 38 of the clip 24, the opposing biased member 28 guide the projection 26 towards the receiving portion 30 as the biased members 28 are forced apart from one another. After the projection 26 is received by the receiving portion 30, the biased members 28 return to their resting position securing the projection 26 within the receiving portion 30 of the clip 24. Although, preferably the biased members 28 are biased against an outer surface of projection 26 when engaged so as to frictionally hold the projection 26 in place.

In addition to simplifying access to the interior of the spa tub 10 for the purposes of inspecting the inner workings 22 and making repairs thereto, the present invention also advantageously reduces, if not eliminates, the mechanical stresses placed on the spa panels 16 as a result of expansion and contraction of the panels 16 due to variations in temperature. When the spa panel 16 is secured to the frame 18, it is understood that as the spa tub panel 16 expands or contracts in either the vertical or horizontal direction as a result of fluctuations in temperature, the clip 24 will move relative to projection 26. However, with reference to FIG. 3B, as is advantageously provided by the present invention, the resilient opposing members 28 of the clip 24 will flex in the direction of relative movement of the clip 24 with respect to the projection 26, thereby reducing mechanical stresses. In contrast, spa panels that are affixed to a frame by screws and other similar mechanisms are less forgiving, and therefore, are susceptible to fatigue and failure as they are subjected to prolonged variations in temperature.

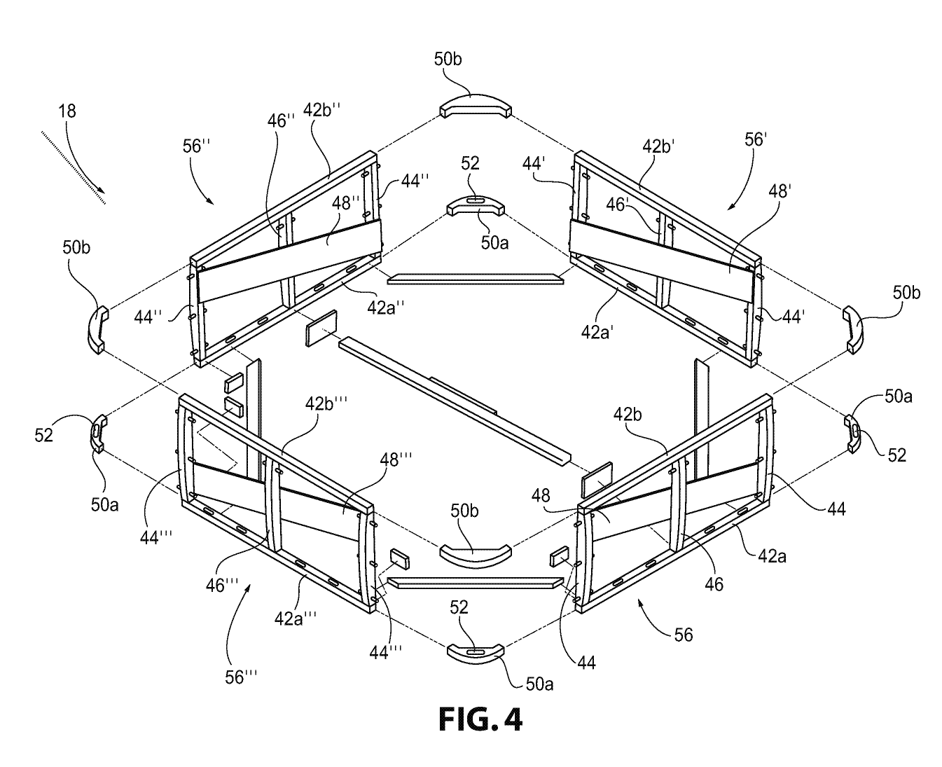

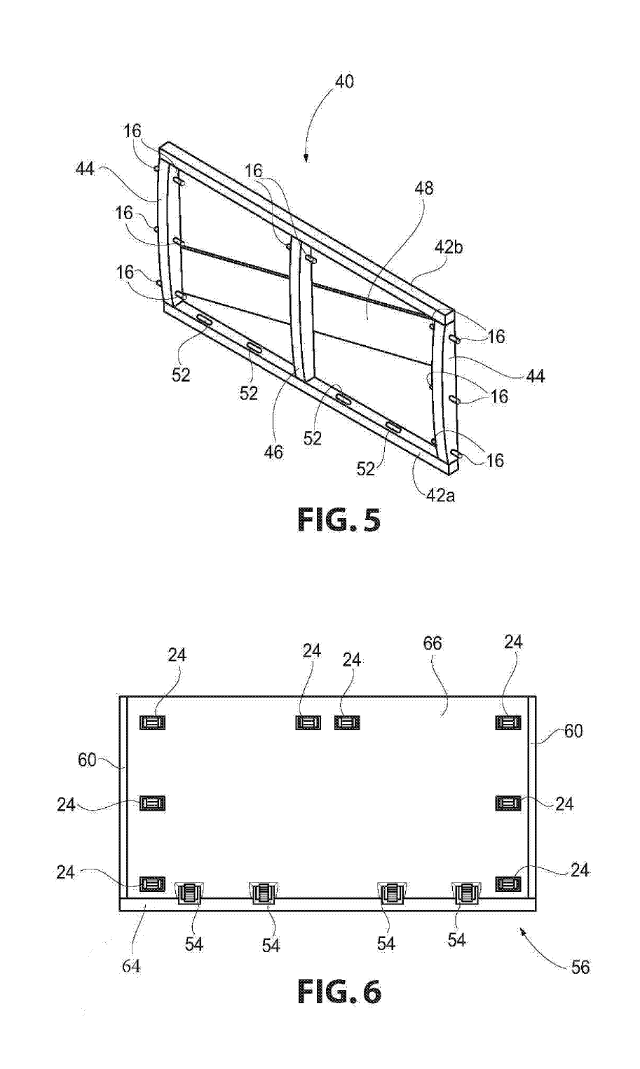

Referring now to FIGS. 4 and 5, the frame 18 includes a side wall 40 having projections 26 extending therefrom. The side wall 40 generally includes beams 42 extending in a first direction, for example, a horizontal direction, end beams 44 extending in a second direction, for example, a vertical direction, and a center beam 46.

As is further detailed in FIG. 5, the side wall 40 includes a lower beam 42a and an upper beam 42b, collectively referred to as the beams 42, and two end beams 44 extending between the beams 42, thereby forming a quadrilateral side wall 40. The center beam 46 extends between the beams 42 and is located a distance between the end beams 44. The side wall 40 may also include a cross beam 48 extending in a third direction that is neither the first direction nor the second direction. The cross beam 48 connects the ends beams 44 and the center beam 46 providing additional support to the side wall 40.

With reference to FIG. 4, the frame 18 includes a plurality of generally identical side walls 40, 40′, 40″, 40″' secured to one another by a plurality of corner beams 50a and 50b. For example, a lower corner beam 50a and upper corner beam 50b, collectively the corner beams 50, connect an end beam 44 from one side wall 40 to an adjacent end beam 44′ of an adjacent side wall 40′, thus securing the side wall 40 and the side wall 40′ to one another. Sidewall 40′ is secured to side wall 40″, which is secured to sidewall 40″' in the same manner, but for the sake of brevity, is not discussed in detail.

With continued reference to FIG. 5, the side wall 40 includes a plurality of projections 26. More specifically, the plurality of projections 26 extend from opposing sides of the end beams 44 and the center beam 46 in a direction substantially parallel to the beams 42. A top surface of the lower beam 42a defines receiving cavities 52 for receiving a mount 54 secured to the spa panels 16 and to align each clip 24 to its corresponding projection 26 as is discussed in detail below. Similarly, a top surface of the lower of corner beam 50a may also define at least one receiving cavity 52 for receiving a mount 54 secured to the spa panels 16 to align each clip 24 to its corresponding projection 26.

The projections 26 extending from the end beams 44 toward the center beam 46 and the projections 26 extending from the center beam 46 are received within clips 24 secured to a spa panel 16, particularly a side spa panel 56, while the projections 26 extending from the end beams 44 away from the center beam 26 receive clips 24 secured to a spa panel 16, particularly a corner spa panel 58.

FIG. 6 illustrates the side panel 56 in detail. The side panel 56 includes clips 24, mounts 54, side panel flanges 60 (FIGS. 3A and 3B), and a lip 64. The lip 64 is configured to abut the lower beam 42a when the side panel 56 is attached to the side wall 40.

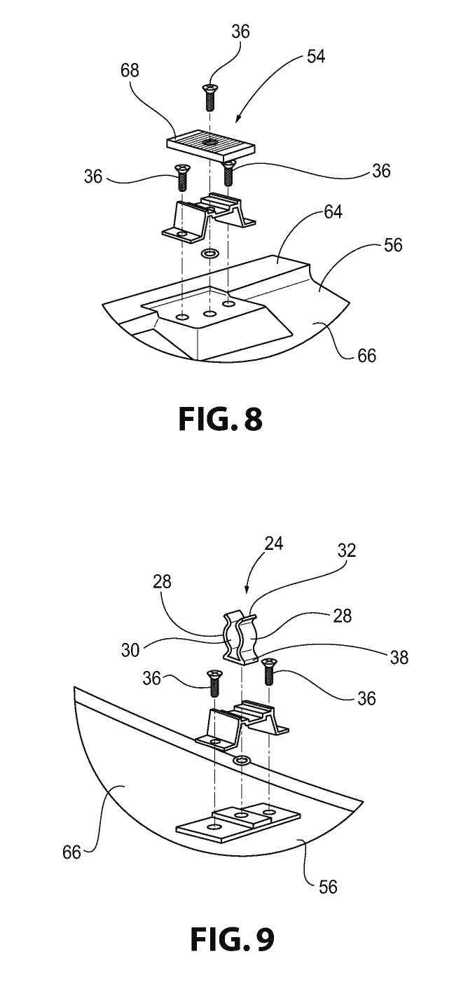

A plurality of clips 24 are secured to bracket 34 via screws 36 and the bracket 34 is secured to rear side 66 of the side panel 56, as shown in FIG. 9. A plurality of mounts 54 are secured to bracket 34 via screws 36 and the bracket 34 is secured to a rear side 66 of the side panel 56 as shown in FIG. 8. With reference to FIG. 6, the mounts 54 are secured to the rear side 66 of the side panel 56 above a top portion of the lip 64.

Referring to FIG. 8, each mount 54 includes a tab 68, which is installed as part of the mount 40 by drilling a hole through the tab 68 and fastening it to the mount 54, for example, via screws. Although FIGS. 8 and 9 illustrate that the clips 24 and the mounts 54 are secured to the rear side 66 of the side panel 56 via screws, other connection mechanisms, such as welding or gluing, have been contemplated.

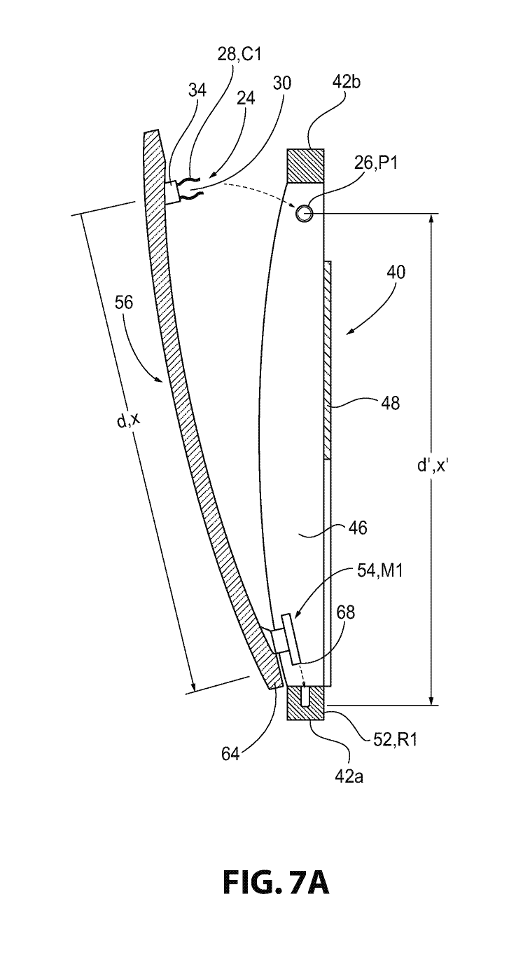

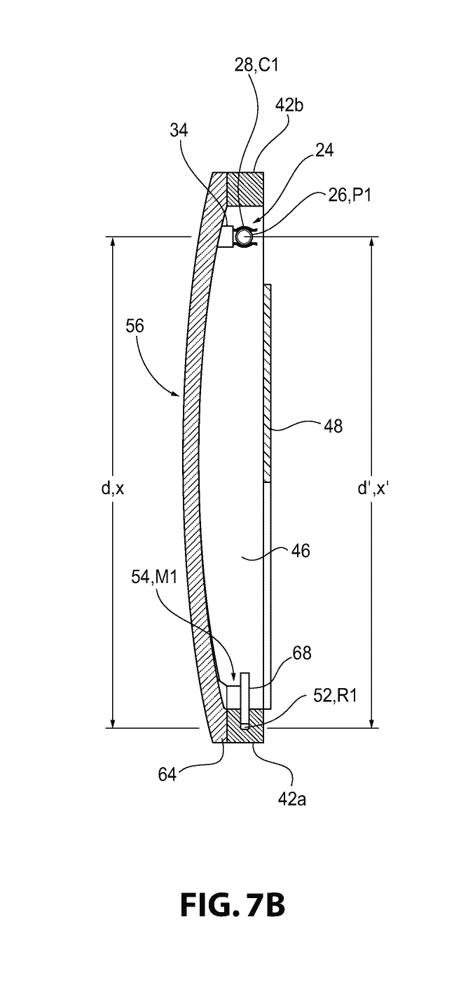

As is further explained, the tab 68 can be used to align the clips 24 to their corresponding projections 26. For simplicity, the following disclosure will explain the mechanism for aligning one particular clip C1 to its corresponding projection P1, with reference to a particular mount M1 and receiving cavity R1, as shown in FIGS. 7A and 7B. The clip Cl is secured to the rear side 66 of the side panel 56 a particular distance (d) and in a particular direction (x) with respect to the mount M1 located on the rear side 66 of the same spa panel 56. The corresponding projection P1 is secured to the frame 18 a particular distance (d′) and in a particular direction (x′) with respect to the receiving cavity R1. The particular distance (d) that the clip Cl is located with respect to the mount M1 is equal to the particular distance (d′) that the projection P1 is located with respect to the receiving cavity R1. Similarly, the particular direction (x) that the clip C1 is located with respect to the mount M1 is equal to the particular direction (x′) that the projection P1 is located with respect to the receiving cavity R 1 . As a result, by inserting the tab 68 of M1 into a receiving cavity R1, a user is able to automatically align clip Cl with its corresponding projection P1 such that the spa panels 16 can be pivoted towards the frame 18 and secured thereto. This mechanism ensures that the projection 26 will always pivot correctly into the receiving portion 30 of the clip 24. Moreover, even if the spa panel 16 experiences a slight expansion or contraction due to changes in temperature, the wider second end 38 of the clip 24 will guide the projection 26 into the receiving portion 30 as previously discussed.

With continued reference to FIG. 7B, when the spa panel 16 is affixed to the frame 18, the tab 68 floats in the receiving cavity 52 (i.e., does not touch a bottom portion of the receiving cavity 52. This arrangement aids in allowing for thermal expansion and contraction to occur without damaging the spa panels 16 as previously discussed.

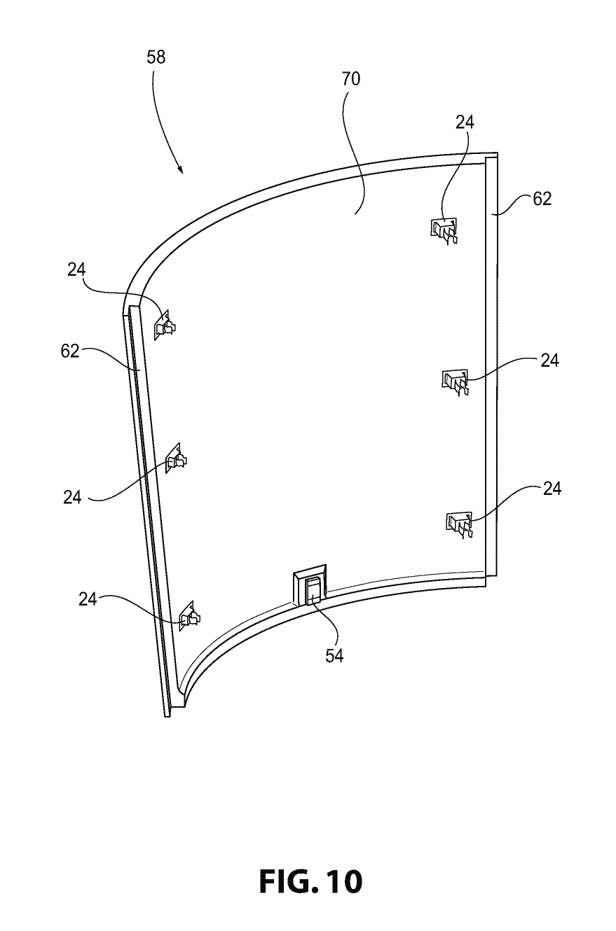

FIG. 10 shows a corner panel 58 in more detail. Clips 24 are secured to the corner panel 58 via bracket 34 and screws 36, as shown in FIG. 9. A plurality of clips 24 are secured to a rear side 70 of the corner panel 58 and near a perimeter thereof. At least one mount 54 may additionally be located on the rear side 70 of the corner panel 58. The corner panels 58 include corner panel flanges 62 located along the peripheral edges of the vertical sides of the corner panels 58. The corner panel flanges 62 are configured to engage the side panel flanges 60 so that the side panel 56 sits flush with and adjacent corner panels 58 when the spa panels 16 are attached to the frame 18.

A method of assembling the spa tub 10 will now be discussed. The method includes providing a frame 18 defining receiving cavities 52 in a portion thereof. The frame 18 includes side walls 40 having projections 26 extending therefrom. The method also includes providing side panels 56 and corner panels 58, collectively referred to as spa panels 16 having a plurality of clips 24 corresponding to each projection 26 and a plurality of mounts 54 corresponding to each receiving cavity 52. The spa panels 16 are attached to the frame 18 by securing the clips 24 of the spa panels 16 onto corresponding projections 26. The spa panels 16 are detachable (i.e. not permanently affixed) to the frame 18. To attach the spa panels 16 to the side walls 40, the mounts 54 are inserted into corresponding receiving cavities 52 of the frame 18, thus aligning the projections 26 and the clips 24, as shown in FIG. 7A. The spa panels 16 are then subsequently pivoted toward the frame 18 until each projection 26 is received within the receiving portion 30 of its corresponding clip 24, as shown in FIG. 7B.

The above-described spa tub 10 advantageously simplifies inspection and repair of the inner workings 22 that would otherwise be inaccessible or complicated to access if the spa panels were permanently attached. Accordingly, the present disclosure streamlines inspection and repair as a user does not need to first detach features such as screws affixing the panels to the frame. In contrast, the spa panels 16 of the present invention are easily removed from the frame 18 by disengaging from the projections 26 from each corresponding clip 24 and then lifting the spa panels 16 to disengage the mount 54 from its corresponding receiving cavity 52.

Once access to the inner workings 22 of the spa tub 10 has been achieved, the inner workings 22 may be inspected or general maintenance/repairs may be performed. The removed spa panel 16 is easily reattached to frame 18 when the inspection, maintenance, or repair has been completed.

The present invention disclosed herein provides for spa panels that are quickly detachable, via snap-fit assembly. As a result, the invention simplifies access to the inner working of the spa tub thereby providing efficient inspection, maintenance, or repair to be performed therein.

While embodiments of a clip design for a spa tub are shown in the accompanying figures and described hereinabove in detail, other embodiments will be apparent to, and readily made by, those skilled in the art without departing from the scope and spirit of the invention. Accordingly, the foregoing description is intended to be illustrative rather than restrictive. The disclosure described hereinabove is defined by the appended claims and all changes to the disclosure that fall within the meaning and the range of equivalency of the claims are to be embraced within its scope.

The claimed invention is:

1. A tub comprising:
a frame and defining a receptacle therein, the frame having a wall comprising one of a projection or a clip; and
a panel comprising the other one of the projection or the clip, wherein receipt of the projection by the clip removably connects the panel to the frame.

2. The tub according to claim 1, wherein the wall comprises a beam extending in a first direction, the beam extending in the first direction defining a cavity for receiving a portion of the panel.

3. The tub according to claim 2, wherein the wall further comprises a beam extending in a second direction and wherein the projection is connected to the beam extending in the second direction.

4. The tub according to claim 1, wherein the panel comprises the clip and wherein the clip is secured to a rear side of the panel.

5. The tub according to claim 2, wherein the panel comprises a mount, a portion of the mount being configured to be inserted into the cavity.

6. The tub according to claim 1, wherein the clip comprises opposing, biased members defining a receiving portion therebetween for receiving and securing the projection.

7. The tub according to claim 1, wherein the frame further comprises a corner beam for connecting a plurality of the walls to each another.

8. The tub according to claim 1, wherein the panel further comprises a lip for abutting with the frame when the panel is connected to the frame.

9. The tub according to claim 5, wherein the mount is secured to a rear side of the panel.

10. The tub according to claim 9, wherein the mount comprises a tab, a portion of the tab being configured to be inserted into the cavity.

11. The tub according to claim 10, wherein when the cavity receives the portion of the tab, the tab floats within the cavity.

12. The tub according to claim 1, wherein the panel comprises a flange configured to engage a flange of an adjacent panel when a plurality of panels are affixed to the frame adjacent to one another.

13. The tub according to claim 6, wherein a shape of the receiving portion of the clip corresponds in shape to a shape of a cross section of the projection.

14. The tub according to claim 13, wherein the projection is cylindrical.

15. A method of making a tub comprising:
providing a frame, the frame defining a receptacle and having a wall comprising a projection or a clip;
providing a panel comprising the other one of the projection or the clip; and
attaching the panel to the frame, wherein receipt of the projection by the clip removably connects the panel to the frame.

16. The method of making the tub according to claim 15, wherein the frame comprises the projection and defines a cavity and the panel comprises a mount and a clip and wherein attaching the panel to the frame further comprises aligning the projection and the clip by inserting a portion of the mount into the cavity.

17. The method of making a tub according to claim 16, wherein with the portion of the mount inserted into the cavity attaching the panel to the frame further comprises pivoting the panel until the clip receives the projection.

18. A method of gaining access to an interior of a tub, wherein the spa tub comprises a frame defining a receptacle, the frame having a wall comprising a projection or a clip and a panel, the panel comprising the other one of the projection or the clip, wherein receipt of the projection by the clip removably connects the panel to the frame, the method of gaining access comprising:
removing the panel;
accessing inner workings of the tub; and
reattaching the panel to the frame.

19. The method of gaining access to the interior of the tub of claim 18, wherein removing the panel further comprises disconnecting the projection from the clip.

20. The method of gaining access to an interior of the tub of claim 19, wherein removing the panel further comprises lifting the panel to disengage a mount secured to the panel from a cavity defined in the frame.
